(19) United States
(12) Patent Application Publication
(10) Pub. No.: US 2015/0317630 A1
(43) Pub. Date: Nov. 5, 2015

(54) METHOD AND SYSTEM FOR AUTHENTICATION TOKEN GENERATION

(71) Applicant: MasterCard Incorporated International, Purchase, NY (US)

(72) Inventors: Brian Piel, Ballwin, MO (US); Mark Hey, St. Peters, MO (US); Paul Baker, Shipley (GB); Gregory D. Williamson, Stamford, CT (US)

(73) Assignee: MasterCard Incorporated International, Purchase, NY (US)

(21) Appl. No.: 14/266,154

(22) Filed: Apr. 30, 2014

(51) Int. Cl. G06Q 20/40

(52) U.S. Cl. CPC G06Q 20/40

(57) ABSTRACT

Methods, media, and systems to receive a request for an authentication value for a transaction in an application programming interface (API) call from a software application; determine the request for the authentication value includes an indication of a first transaction type; generate, in response to the determination that the request for the authentication value includes an indication of the first transaction type, an authentication value for the transaction; and as an indication of a verified authentication send, to the software application, an API response including the generated authentication value for the transaction.

### BACKGROUND

Traditionally, a major concern of merchants and issuers of payment cards (such as credit or debit cards) in a transaction where the cardholder is not physically present with the payment card at the time a payment or purchase is being made is whether the person attempting to use the card is in fact an authorized cardholder or user of the card. When a cardholder is not present, it may be difficult for the merchant to authenticate of verify that the actual cardholder is indeed authorizing a purchase.

In an effort to reduce the incidence of credit card fraud in online purchase transactions, a number of systems have been proposed and used to verify that the person using the card is authorized to use the card. However, processes and systems proposed heretofore are typically complex and costly to implement.

Therefore, it would be desirable to provide improved methods and apparatus for efficiently facilitating and processing authentication of an entity.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 is an illustrative depiction of a system for use in a general cardholder authentication;

FIG. 2 is an illustrative depiction of a system, according to some embodiments herein;

FIG. 3 is a flow diagram of a process, in accordance with some embodiments herein; and

FIG. 4 is schematic block diagram of an apparatus, according to some embodiments herein.

### DETAILED DESCRIPTION

In general, and for the purpose of introducing concepts of embodiments of the present disclosure, an authentication security policy relates to a process of verifying cardholder account ownership during a transaction in an online electronic commerce (e-commerce) environment, where that transaction may include a purchase transaction. As used herein, the terms purchase transaction and payment transaction or simply transaction may be used interchangeably unless stated otherwise. In general, the purchase transactions herein refer to card not present or e-commerce transactions. As such, these transactions may be requested by a merchant or other entity to have the cardholder, user, or other entity presenting a payment device for payment verified as an authorized user of the payment device since, for example, a merchant cannot physically verify the user is even in possession of the payment device.

A number of methods, systems, and solutions have been proposed to provide a cardholder authentication process. One solution is MasterCard® SecureCode™ promulgated by the assignee of the present patent application that defines and provides a level of security relating to a cardholder authentication process. The MasterCard® SecureCode™ process incorporates aspects of the 3-D Secure™ Protocol Specification Core Functions, Version 1.0.2 effective 17 Apr. 2006. This particular implementation of 3-D Secure™ includes support for the SPA (Secure Payment Application) algorithm and Universal Cardholder Authentication Field (UCAF) without changing the 3-D Secure™ specification, messages, or protocol. While some aspects herein may build on, rely on, and leverage various aspects of the 3-D Secure™ specification, the processes and systems herein are not limited to a security authentication protocol or process adhering to that specification. Even in some instances herein where some embodiments may be described in the context of a system and process interfacing with at least some aspects of the 3-D Secure™ specification, other or alternative security protocols may be substituted without any loss of generality, including those now now and those that are developed in the future.

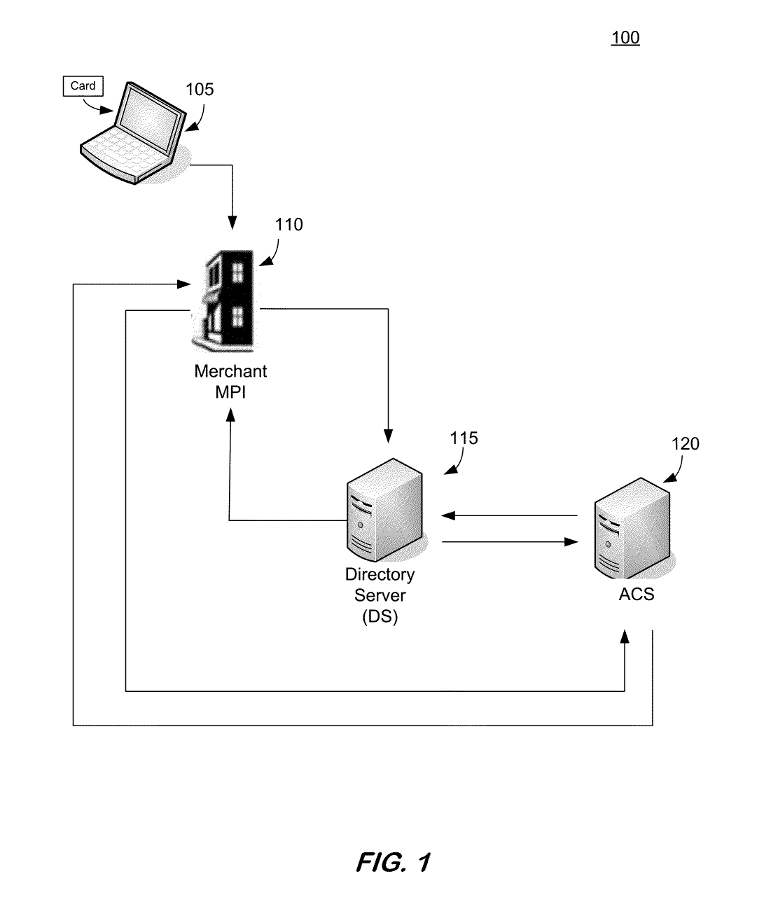

FIG. 1 is an illustrative diagram of a system 100 for implementing a process that may be utilized for verifying a cardholder account ownership (i.e., cardholder authentication) in accordance with the 3-D Secure™ specification. As such, FIG. 1 provides, in part, an overview of a cardholder authentication system and process in accordance with the 3-D Secure™ specification. However, all details of the specification are not discussed herein since a complete detailed disclosure of such information may be readily understood by directly referencing the 3-D Secure™ specification and or discussions thereof.

System 100 includes a plurality of entities that must interact with each other by exchanging multiple, specifically formatted messages over secure communication channels (defined in the 3-D Secure™ specification). Accordingly, the cardholder authentication process of FIG. 1 is complex given the number and extent of entities, messages, and other requirements necessarily involved.

System 100 includes a cardholder 105 that interacts with a merchant's online presence. Typically, cardholder 105 visits a merchant's Web site using a browser on their device of choice and selects items for purchase. As part of the online ordering process, cardholder 105 checks out and finalizes the purchase transaction by providing payment credentials to the merchant. The payment credentials may include at least a primary account number (PAN) representing the account to be used as a source of funds in the transaction, an expiration date associated with the PAN, and (billing) address information of the cardholder. The PAN and other information is provided to the merchant's Merchant Server Plug-in (MPI) 110, where the MPI is a software module executed on behalf of the merchant. MPI 110 operates to determine whether payment authentication is available for the PAN received from the cardholder. The MPI formats and sends a Verify Enrollment Request (VEReq) message including the PAN to a Directory Sever (DS) 115, where the DS is a computer server that can determine whether the PAN is within a range of PANs enrolled in the authentication service provided by system 100. The DS may comprise a computer having at least one processor, a memory to store program instructions and data, and a communication interface to interface with other devices.

Upon receiving the VEReq, DS 115 queries an Access Control Server (ACS) 120 device, where the address of the ACS is specified in the VEReq. The address of the ACS may be specified using a Web address URL (uniform resource locator) for the ACS. The specified ACS may be an issuer of the account represented by the PAN. In some embodiments, the ACS may be acting on behalf of the issuer of the PAN and the specified URL points to a Web address other than that of the issuer. ACS 120 may respond to the query by providing an indication of whether authentication is available for the PAN included in the VEReq. If the merchant is a participating acquirer and the merchant is a valid merchant, then ACS 120 may respond with a Verify Enrollment Response, VERes, that indicates that authentication is available for the PAN. ACS 120 uses the PAN from the VEReq to determine whether the cardholder is enrolled.

In some instances, the MPI may store data related the ranges of PANS enrolled in the authentication service and determine whether the PAN is within a range of PANs enrolled in the authentication service provided by system 100.

In some aspects, the VERes may include a flag that authentication is available for the PAN (e.g., a PAN Authentication Available field may be set to “Y” indicating authentication is available). Conversely, ACS 120 may respond with a VERes that indicates that authentication is not available for the PAN (e.g., acquirer BIN and/or PAN not enrolled, ACS unresponsive to query, etc.). In some aspects, the VERes may include a flag that authentication is not available for the PAN (e.g., a PAN Authentication Available field may be set to “N” indicating authentication is not available or “U” indicating authentication is unavailable). In the event the VERes includes a flag, a value in a field thereof, or other mechanism to indicate that authentication is not available for the PAN, the authentication process provided by system 100 may be terminate or aborted.

ACS 120 further sends the VERes including the indication of whether authentication is available to DS 115. DS 115 will then forward the VERes to MPI 110. This may conclude the DS's participation in the authentication of the transaction but the authentication process is far from complete. Upon receipt of the VERes, MPI 110 reads the response to see if authentication is available for the transaction's PAN. If authentication is available, then MPI 110 sends a message including a Payer Authentication Request, PAReq, to ACS 120 via the cardholder's browser using the ACS URL included in the VERes. The PAReq message requests the issuer ACS to authenticate its cardholder. The PAReq may include cardholder, merchant, and transaction-specific information. The cardholder information may include security information known only to the cardholder and the issuer. It is noted that the PAReq message is not shared with the merchant (or the MPI).

ACS 120 receives the PAReq and may proceed to validate the received message to ensure that it is properly formatted and includes the requisite information, including for example, digital certificates and a proper PAN Authentication Available flag (e.g., “Y”). ACS 120 may further determine whether to provide authentication of the cardholder. ACS may provide an indication of that determination by providing a status for the transaction. Values for the status may include, in accordance with 3-D Secure™, “Y” meaning the customer is fully authenticated, “N” meaning the customer failed or canceled authentication (i.e. transaction denied), “U” meaning the authentication could not be completed (e.g., technical issues such as communication failures, time-outs, etc.), and “A” that provides proof that the authentication was attempted.

A message is sent from ACS 120 to MPI 110 that includes the transaction status as determined by ACS 120. The message may comprise a Payer Authentication Response, PARes. In the event the transaction status is determined to be “Y”, then the PARes will include an authentication token, AAV, that is sent to MPI 110. The PARes may be digitally signed to offer a level of security regarding the authenticity of the message itself. The PARes is received at MPI 110 through the cardholder's browser. Upon receipt of the PARes, MPI 110 may operate to validate the signature of the PARes and determine whether to authorize the transaction based, at least in part, on the values comprising the VERes.

If the cardholder is authenticated using the authentication process generally described above, then the purchase transaction may proceed to a purchase or payment authorization process and informs the MPI of the AAV value or token. The purchase authorization may be accomplished in a conventional manner after the MPI notifies the merchant payment system of the results of the authentication attempt.

In some instances, if the authentication was not successful, the merchant may still proceed with a conventional transaction authorization without the authentication token as an unauthenticated transaction. Liability for the processing of an unauthenticated transaction may reside with the merchant.

As noted in conjunction with FIG. 1, numerous messages may typically be communicated between numerous different entities. As such, a cardholder authentication process may typically be a complex process given the number of parties involved, the number of specific messages that are exchanged between the different entities, the number of determinations that need to be made regarding the content of the exchanged messages, and the secure communication of the messages.

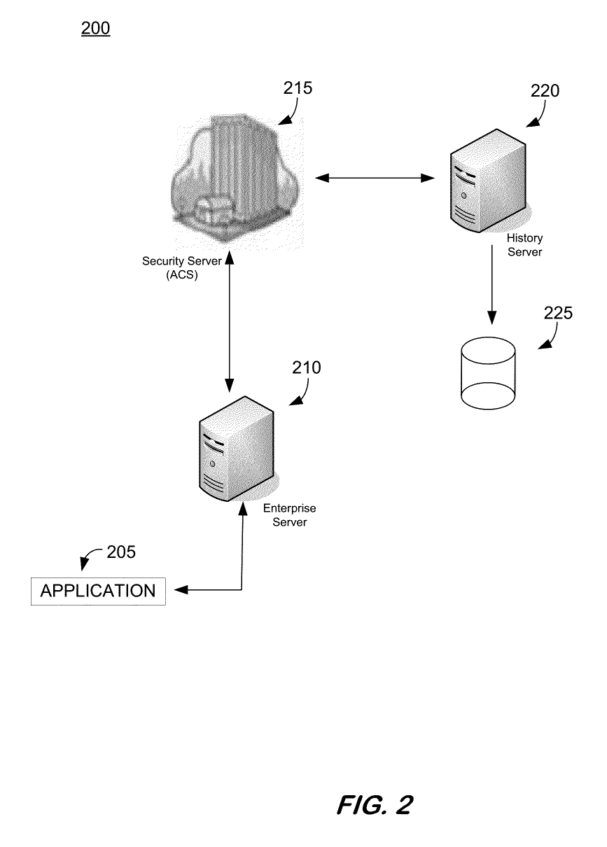

FIG. 2 discloses a system 200 in accordance with some embodiments herein. System 200 includes an application 205. In some embodiments, application 205 may be internal to an enterprise, business, or other organization. As used herein, an “internal” application is not exposed to a system, device, service, or communication channel outside of the particular enterprise, business, or other organization. In some embodiments, application 205 may be a software application configured in accordance with an API (application program interface) specification herein. The API may be referred to as an authentication API herein. The authentication API may specify the information to be include in an exchange of information between application 205 and another software application, device, system, or service such as, for example, an enterprise server 210. Enterprise server 210 may operate to receive a request for an authentication value or token from application 205 via an API call and in reply to that API call (i.e., request) send an authentication value via an API response to software application 205.

In some embodiments, the requested authentication value may comprise a security code that is compatible with a Universal Cardholder Authentication Field (UCAF) data structure that is compatible with an authentication payment environment. It is noted however that an authentication value in some embodiments herein is not limited to the UCAF data structure or an instance thereof.

In some embodiments, the authentication payment environment may comprise a three-domain (3-D) security protocol. In some embodiments and aspects, a process of generating and communicating the API call and the API response in reply thereto and the systems and devices to execute that process are separate and distinct from the security protocol. In some embodiments, aspects of a method and process herein may, in some instances, provide information to and/or receive information from a process and system comprising a security protocol but be distinct therefrom.

In one aspect, the request for an authentication value or token may be for a specific, particular transaction, where the authentication value returned or sent to calling application 205 in reply to the API call provides an authentication value that is valid for and specifically associated with the transaction specified in the API call. In some embodiments, the authentication value or token sent from enterprise server 210 to application 205 may be used by application 205 and/or other applications, systems, devices, and services in a process performed by application 205 and/or the other applications, systems, devices, and services. As an example, the authentication value generated by enterprise server 210 and sent to application 205 in response to the API call from the application may be used as an indicator (i.e., proof) of a verified authentication and further included in a payment transaction authorization request or other process. In some embodiments, the authentication value may be formatted and encoded in a suitable manner (e.g., formatted, encoded, encrypted, etc.) such that a particular authorization request including the authentication value herein need not be altered to accommodate the authentication value and otherwise be processed. Accordingly, some embodiments of FIG. 2 may interface with and accommodate systems and processes including those currently known and future developed systems and process that may, at least in part, conform to one or more security protocols.

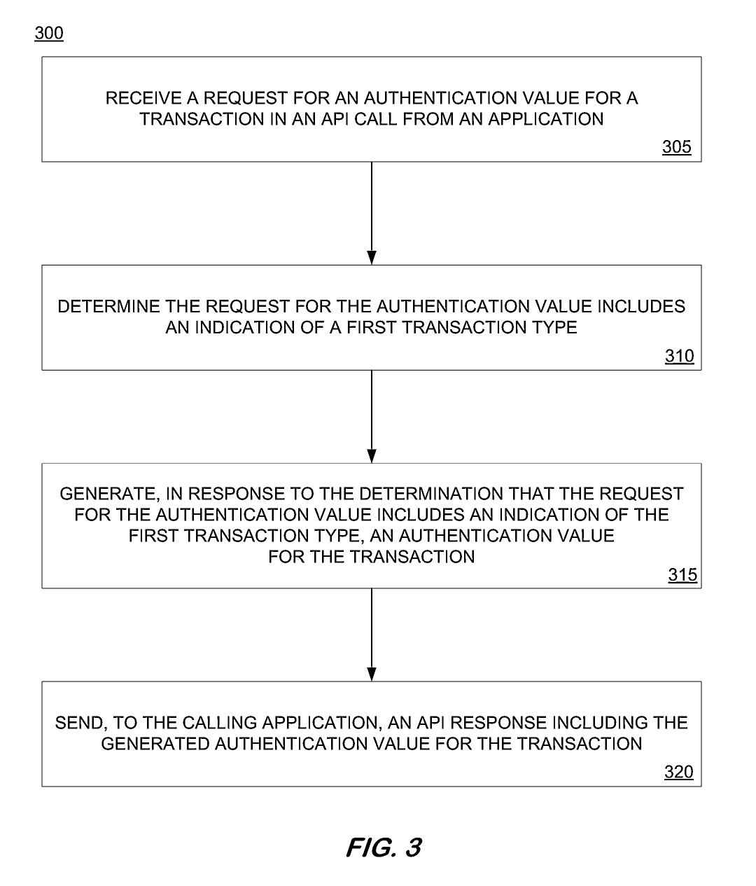

In some embodiments, it is noted that application 205 makes the authentication request using a single API call to enterprise server 210. Conversely, the enterprise server may provide a reply to application 205 using a single API response. In this manner, an authentication value may be obtained in an efficient process by requesting and receiving an authentication value or token using a single API call from an application. In some aspects, this is in contrast to the processes disclosed in, for example, FIGS. 3 and 5, that involve multiple different entities that necessarily communicate with each in a specific sequence(s) while exchanging specific messages adhering to specific message formats and communication session requirements, per a specific security protocol.

Referring to process 300 depicted in FIG. 3, a software application 205 makes an API call to enterprise server 210 at operation 305. From the perspective of the enterprise server 210, the API call requesting the authentication value is received by the enterprise server at operation 305. In some instances, the API call may comprise a SOAP (Simple Object Access Protocol) message, although other data communication protocols may be used without a loss of generality.

At operation 310, the enterprise server 310 may determine whether the request for the authentication value includes an indication that the request comprises a first transaction type. The first transaction type may be indicated by a value, a flag, a data field, or other mechanism included in or associated with the received API call. In one embodiment, the API call may comprise a message of a particular format that includes a parameter in a data field of the message where a particular value for that parameter indicates that the API call is to be processed in accordance with the subsequent operations 315 and 320 of process 300. In one embodiment, the indication that the request comprises a first transaction type is provided by virtue of the API call itself. That is, since the enterprise server receives an API call requesting an authentication value, as opposed to receiving no API call or receiving some other type of message or request, then the API call may be further processed in accordance with process 300.

In some embodiments, the secure server 215 depicted in FIG. 2 may include an ACS or the like, where enterprise server 210 is placed in front of the secure server. In an instance a message received by enterprise server 210 is a security message conforming to a security protocol (e.g., SPA, 3-DS, etc.), then the message may be routed to security server 215 (i.e., ACS) and processed according to the applicable security protocol. In this instance, the message received by enterprise server 210 would be received from one of the entities specified by the security protocol, such as, for example, a merchant, a MPI, and a cardholder (e.g., an in-line browser window, etc.) in the particular format and including the data specified by the specific protocol. In some embodiments, enterprise server 210 may route some message of a particular type to an ACS for processing by the ACS in accordance with one or more security authentication protocols.

Returning to FIG. 3, process 300 proceeds to operation 315 where, in response to the determination that the request for the authentication value includes an indication of a first transaction type, the enterprise server generates an authentication value for the transaction associated with the API call received at operation 305. In some embodiments, generation of the authentication value or token may include the enterprise server 210 transforming the API call received from the software application to a verification request message (e.g., VEReq). The verification request message may be transmitted to a security protocol processing backend system (e.g., a security authentication system including an ACS). Enterprise server 210 may receive, in reply to the verification request message, a verification response message (e.g., VERes). In some instances, the verification request message and the verification response message may be exchanged over a same communication (e.g., HTTP) session. Upon receipt of the verification response message, enterprise server 210 may generate or otherwise formulate a payer request message that is subsequently transmitted to the security protocol processing backend system (e.g., an issuer ACS) for processing. Enterprise server 210 may receive, in reply to the payer request message, a payer response message (e.g., PARes). In some instances, the payer request message and the payer response message may be exchanged over a same communication (e.g., HTTP) session. The authentication value or token may be generated based on the payer response message.

At operation 320, an API response including the generated authentication value may be sent to the calling application (e.g., application 205). In some instances, the generated authentication value may be used by the calling application for reporting, analysis, dispute resolution, liability shifting, and further processing (e.g., included in a payment transaction authorization request) message.

In some aspects, the API call and the API response in reply thereto are internal to a particular business, system, organization, or other environment. In some regards, a context such as this where the data exchanged via the API calls and API response is not exposed externally may, for at least this reason, fall outside of the purview of one or more security protocols.

In some embodiments, the authentication API herein may include one or more data fields. Table 1 below is a tabular listing of some data fields that may be specified for implementing an API that may be used by a web service or application in accordance with some embodiments herein. In some embodiments, the data fields listed in Table 1 may be described in an interface description language (e.g., Web Service Description Language, WSDL) and provided to a developer of a web service or application for use by the developer or other entity to generate a web service or application that may effectively communicate using an appropriately define API.

In some embodiments, the authentication API may require or expect a value to be specified for all of the data fields listed in Table 1. That is, the API call may include a corresponding value for each of the data fields listed in the table. In some other embodiments, some but not necessarily all of the data fields specified in Table 1 may have a corresponding value supplied in the API call. For example, some instances of an authentication API herein may specify a value for a PAN (i.e., payment account number), a merchant name, and an expiry date corresponding to the PAN. These minimal values may be included in the API call and may be sufficient for the request of an authentication value in some embodiments herein.

TABLE 1

| | | | Server |
|---|---|---|---|
| Field | | | Edit |
| Name | Schema Element | Field Description | Criteria |
| Application | applicationIdentifier | API Assigned | Length: |
| Identifier | | Application Identifier | 1-16 |
| | | | characters |
| Transaction | transactionIdentifier | Transaction identifier | Length: |
| Identifier | | determined by calling | 28 |
| | | App. Contains a 20 byte | characters |
| | | value that has been | Format: |
| | | Base64 encoded, giving | any |
| | | a 28 byte result. This | character |
| | | should be unique for | |
| | | each transaction for | |
| | | reporting purposes. | |
| Cardholder | accountNumber | Account Number; it | Length: |
| PAN | | should be the same | 13-19 |
| | | PAN that will be | characters |
| | | used in the | Format: |
| | | authorization request. | numeric |
| | | The value may be: | digits |
| | | the account number on | |
| | | the card, a permanent | |
| | | account number that is | |
| | | only used online, | |
| | | produced by the | |
| | | wallet as a | |
| | | proxy, pulled from | |
| | | the merchant's local | |
| | | wallet, any other | |
| | | number that can be | |
| | | submitted for | |
| | | authorization. | |
| Card | expiryDate | Expiration Date | Length: |
| Expiry | | supplied to merchant | 4 |
| Date | | by cardholder | characters |
| | | (YYMM). | Format: |
| | | | numeric |
| | | | digits |
| Acquirer | acquirerBin | Acquiring institution | Length: |
| BIN | | identification code. | 1-11 |
| | | | characters |
| | | | Format: |
| | | | numeric |
| | | | digits |
| Merchant | merchantID | Acquirer-defined | Edit |
| ID | | merchant identifier. | Criteria: |
| | | | Length: |
| | | | 1-24 |
| | | | characters |
| | | | Format: |
| | | | any |
| | | | characters |
| Merchant | merchantName | Merchant name | Length: |
| Name | | to be displayed | 1-25 |
| | | onAuthentication | characters |
| | | Request Page. | Format: |
| | | | any |
| | | | characters |

In some embodiments, an application operative in accordance with process 300 may include a electronic payment wallet application developed on behalf of an issuer. As part of the development and deployment of the electronic wallet, authentication of the electronic wallet may be assigned or passed to a payment network provider or other entity. At the time of a log-in for the wallet application, there may be some level of authentication that verifies the authenticity or identity of the wallet application with the issuer of the wallet. Accordingly, there may not be a need for a merchant at the time of a purchase involving a customer to authenticate the wallet at a check-out since the wallet application has already been authenticated with the issuer. In some instances, the wallet authentication is done as part of a wallet initiation process.

While the user associated with the wallet application of this example has already been authenticated with the issuer to a level of authentication determined and designed to satisfy the concern(s) of the issuer and/or others (i.e., “pre-authenticated”), the particular authentication may not provide an authentication value or token such as an AAV value that may normally be generated by a security protocol. In an effort to obtain an authentication value or token (e.g., a AAV value), the electronic wallet application may request the authentication value via an API call in accordance with the present disclosure. The API call may be presented directly to a service to pull an authentication value therefrom. In some aspects, the API call from the application may obtain the authentication value without the need to satisfy all of the requirements of one or more security protocols since, for example, the issuer or an entity acting on behalf thereof has agreed to processing of the API call given certain conditions are satisfied. In some embodiments, an agreement to accept and process the API calls from an application in accordance with the present disclosure are determined before the API call is received by an enterprise server herein (e.g., before an operation 305 of process 300). In some aspects, the authentication of the electronic wallet in the present example may be said to comprise a pre-authorized authentication.

In some embodiments, a policy governing the authentication of the electronic wallet or other calling application may vary depending on the calling application, the intended use of the authentication value or token by the calling application, and other considerations.

Continuing with the electronic wallet example, in an instance a customer cardholder logs into a merchant's wallet service, the customer registered with the wallet service may be considered to have already been authenticated (i.e., pre-authorized authentication). In this case however, an authentication value or token may be desired for use in a payment authorization request associated with a purchase transaction of the customer. In some embodiments, the payment authorization request will be expected by an issuer (or entity acting on behalf thereof) to include the authentication value or token. In some aspects, the payment authorization may not be processed in the absence of the expected authentication value or token.

In some embodiments, inclusion of the authentication value or token in the payment authorization request may facilitate processing of the payment authorization in accordance with a known or predetermined process flow. The absence of the expected authentication value or token in the payment authorization request may trigger the processing of the payment authorization in accordance with an alternative or “exceptions” process flow or a termination of the process flow.

In some embodiments, security server 615 may forward a record or representation of the authentication value or token generated by enterprise server 210 615 to a history server 220. History server 220 may further send transaction details to a database 225. The transaction details may be used in further processing, reporting, and analytics.

In some aspects, the processes disclosed herein may be combined, at least in part. For example, individual processes and individual operations therein may be combined to effectuate different authentication processes, in accordance with some aspects herein.

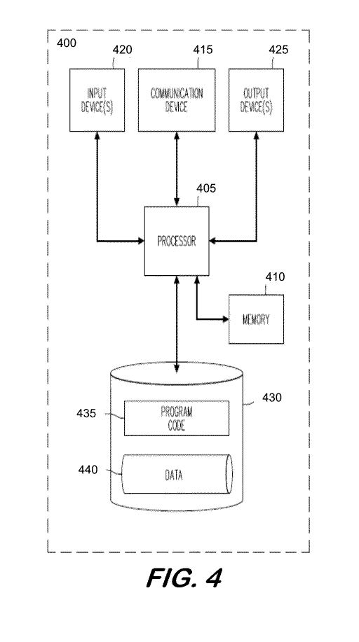

FIG. 4 is a block diagram overview of a system or apparatus 400 according to some embodiments. System 400 may be, for example, associated with any of the devices described herein, including for example an enterprise server and like functionality in accordance with processes disclosed herein. System 400 comprises a processor 405, such as one or more commercially available Central Processing Units (CPUs) in the form of one-chip microprocessors or a multi-core processor, coupled to a communication device 415 configured to communicate via a communication network (not shown in FIG. 4) to another device or system. In the instance system 400 comprises a server (e.g., supporting the functions and services provided by an enterprise server), communication device 415 may provide a mechanism for system 400 to interface with another device, system, or service (e.g., an instance of a security server 215). System 400 may also include a local memory 410, such as RAM memory modules. The system further includes an input device 420 (e.g., a touchscreen, mouse and/or keyboard to enter content) and an output device 425 (e.g., a touchscreen, a computer monitor to display, a LCD display).

Processor 405 communicates with a storage device 430. Storage device 430 may comprise any appropriate information storage device, including combinations of magnetic storage devices (e.g., a hard disk drive), optical storage devices, solid state drives, and/or semiconductor memory devices. In some embodiments, storage device 430 may comprise a database system.

Storage device 430 may store program code or instructions 435 that may provide computer executable instructions for processing authentication value or token requests including, in some aspects the generation of an authentication value or token via an application API call, in accordance with processes herein. Processor 405 may perform the instructions of the program instructions 435 to thereby operate in accordance with any of the embodiments described herein. Program code 435 may be stored in a compressed, uncompiled and/or encrypted format. Program code 435 may furthermore include other program elements, such as an operating system, a database management system, and/or device drivers used by the processor 405 to interface with, for example, peripheral devices. Storage device 430 may also include data 440 such as database records or look-up tables, including for example records of merchants and/or PANs enrolled in a particular authentication program or service. Data 440 may be used by system 400, in some aspects, in performing one or more of the processes herein, including individual processes, individual operations of those processes, and combinations of the individual processes and the individual process operations.

All systems and processes discussed herein may be embodied in program instructions stored on one or more non-transitory computer-readable, processor-executable media. Such media may include, for example, a solid state drive, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, the method comprising:
receiving a request for an authentication value for a transaction in an application programming interface (API) call from a software application;
determining, by a processor, the request for the authentication value includes an indication of a first transaction type;
generating, by the processor in response to the determination that the request for the authentication value includes an indication of the first transaction type, an authentication value for the transaction; and
sending, to the software application, an API response including the generated authentication value for the transaction.

2. The method of claim 1, wherein the API call including the request for the authentication value is received from a software application within a particular enterprise environment that is not exposed to either of an application, a service, or a communication channel outside of a particular enterprise environment.

3. The method of claim 1, wherein the authentication value comprises a Universal Cardholder Authentication Field.

4. The method of claim 1, wherein the generating comprises:
transforming the API call received from the software application to a verification request message;
receiving, in reply to the verification request message, a verification response message;
generating, in reply to receiving the verification response message, a payer request message; and
receiving, in reply to the payer request message, a payer response message.

5. The method of claim 1, wherein the first transaction type comprises at least one of a pre-authenticated application and a pre-authenticated entity.

6. The method of claim 1, wherein the generated authentication value is suitable to use as an indication of a verified authentication in a payment authorization request.

7. A system comprising:
an authentication server; and
an apparatus comprising:
a processor; and
a memory device in communication with the processor and storing program instructions thereon, the processor operative with the program instructions to:
receive a request for an authentication value for a transaction in an application programming interface (API) call from a software application;
determine, by a processor, the request for the authentication value includes an indication of a first transaction type;
generate, by the processor in response to the determination that the request for the authentication value includes an indication of the first transaction type, an authentication value for the transaction; and
send, to the software application, an API response including the generated authentication value for the transaction.

8. The system of claim 7, wherein the API call including the request for the authentication value is received from a software application within a particular enterprise environment that is not exposed to either of an application, a service, or a communication channel outside of a particular enterprise environment.

9. The system of claim 7, wherein the authentication value comprises a Universal Cardholder Authentication Field.

10. The system of claim 7, wherein the processor is further operative with the program instructions to:
transform the API call received from the software application to a verification request message;
receive, in reply to the verification request message, a verification response message;
generate, in reply to receiving the verification response message, a payer request message; and
receive, in reply to the payer request message, a payer response message.

11. The system of claim 7, wherein the first transaction type comprises at least one of a pre-authenticated application and a pre-authenticated entity.

12. The system of claim 7, wherein the generated authentication value is suitable to use as an indication of a verified authentication in a payment authorization request.

13. A medium having program instructions stored thereon, the medium comprising:
program instruction to receive a request for an authentication value for a transaction in an application programming interface (API) call from a software application;
program instruction to determine the request for the authentication value includes an indication of a first transaction type;
program instruction to generate, in response to the determination that the request for the authentication value includes an indication of the first transaction type, an authentication value for the transaction; and
program instruction to send, to the software application, an API response including the generated authentication value for the transaction.

14. The medium of claim 13, wherein the API call including the request for the authentication value is received from a software application within a particular enterprise environment that is not exposed to either of an application, a service, or a communication channel outside of a particular enterprise environment.

15. The medium of claim 13, wherein the authentication value comprises a Universal Cardholder Authentication Field.

16. The medium of claim 13, wherein the medium further comprises:
program instructions to transform the API call received from the software application to a verification request message;
program instructions to receive, in reply to the verification request message, a verification response message;
program instructions to generate, in reply to receiving the verification response message, a payer request message; and
program instructions to receive, in reply to the payer request message, a payer response message.

17. The medium of claim 13, wherein the first transaction type comprises at least one of a pre-authenticated application and a pre-authenticated entity.

18. The medium of claim 13, wherein the generated authentication value is suitable to use as an indication of a verified authentication in a payment authorization request.
